(19) United States
(12) Patent Application Publication
(10) Pub. No.: US 2024/0278760 A1
(43) Pub. Date: Aug. 22, 2024

(54) BRAKING SYSTEM FOR A VEHICLE AND METHOD FOR BRAKING A VEHICLE

(71) Applicant: ZF Active Safety GmbH, Koblenz (DE)

(72) Inventor: Andreas Marx, Hartenfels (DE)

(21) Appl. No.: 18/581,088

(22) Filed: Feb. 19, 2024

(30) Foreign Application Priority Data
Feb. 17, 2023 (DE) 102023104056.1

(51) Int. Cl. B60T 13/74; B60T 8/171; B60T 8/172

(52) U.S. Cl. CPC B60T 13/74; B60T 8/171; B60T 8/172; B60T 2270/402; B60T 2270/414

(57) ABSTRACT

A braking system for a vehicle with at least two brakable wheels is provided, comprising at least two brake actuator units which can be assigned in each case to one of the wheels of the vehicle, at least a first energy supply unit and a second energy supply unit for supplying the brake actuator units with electrical energy, a control unit which is configured to activate the brake actuator units in order to exert a braking force on an assigned wheel, and a switching unit. The switching unit is configured to connect the brake actuator units in terms of energy either to the first energy supply unit or the second energy supply unit in order to enable the supply of energy to the corresponding brake actuator unit from the energy supply unit which is connected in each case. A method for braking a vehicle is furthermore provided.

### CROSS-REFERENCE TO RELATED APPLICATION

This application claims priority to German Priority Application No. 102023104056.1, filed Feb. 17, 2023, the disclosure of which is incorporated herein by reference in its entirety.

### TECHNICAL FIELD

The disclosure relates to a braking system for a vehicle having at least two brakable wheels.

### BACKGROUND

In modern vehicles, a brake actuator unit with an electromechanical brake actuator is assigned in each case to individual wheels. Such braking systems are referred to as “brake-by-wire” systems.

In such systems, a request by a driver of the vehicle to brake is made simply by a brake pedal. On the basis of this braking request, the individual brake actuator units are then activated by one or more electronic control units. There is no mechanical connection between the brake pedal and the brake actuator units.

Because a braking system is a safety-related device of a vehicle, at least certain components or functions within the braking system are usually designed redundantly such that the braking system can work reliably even when a malfunction or a defect occur. In other words, redundancies are provided within a braking system in order to achieve a high degree of operational safety.

In previous “brake-by-wire” systems, an additional hydraulic braking apparatus is, for example, provided as a fallback level.

However, this entails a great deal of effort and high costs. Furthermore, additional structural space is required and the weight of the vehicle is increased.

### SUMMARY

What is needed therefore, is to provide an optimized braking system which has a high degree of operational safety.

A braking system for a vehicle with at least two brakable wheels is disclosed herein. The braking system comprises at least two brake actuator units which can be assigned in each case to one of the wheels of the vehicle, and at least a first energy supply unit and a second energy supply unit for supplying the brake actuator units with electrical energy, a control unit which is configured to activate the brake actuator units in order to exert a braking force on an assigned wheel, and a switching unit which is configured to connect the brake actuator units in terms of energy either to the first energy supply unit or the second energy supply unit in order to enable the supply of energy to the corresponding brake actuator unit from the energy supply unit which is connected in each case.

Such a braking system has the advantage that energy can be supplied to the brake actuator units from two different energy supply units. A particularly high degree of flexibility of the energy supply is achieved as a result. Specifically, a certain redundancy in the energy supply is achieved, as a result of which particularly high operational safety of the braking system is ensured. For example, it is possible to react flexibly to possible malfunctions of one of the two energy supply units.

However, the advantages of the braking system according to the disclosure are apparent not only in the event of a failure of one of the two energy supply units. The possibility of controlling the supply of energy to the brake actuator units from different energy supply units is also advantageous when, for example, individual brake actuator units have an elevated energy requirement, for example, in the peak load range. Because, for example, two brake actuator units which are activated at the same time in the peak load range can be interconnected with different energy supply units, it is possible to ensure that the energy requirement of the brake actuator units is met. It is consequently also possible to form the two energy supply units with a lower capacity, which is advantageous in terms of the production costs and the structural space requirement.

A sufficient braking force in the whole system is achieved by the distribution of the available braking force over the brake actuator units.

The disclosure makes use of the non-linear efficiency curve of the brake actuator units. The braking characteristics of the brake actuator units are degressive in the upper force range, i.e. the efficiency decreases as the energy requirement rises. In other words, a current requirement of the brake actuator units in the peak load range rises disproportionately. The reason for this is that, in the case of relatively high clamping forces, the friction in the system rises and in addition magnetic saturation effects cause a deterioration in the overall efficiency.

Specifically, in the event of a failure of one of the two energy supply units, a braking force of over 50% compared with regular operation of the braking system is achieved.

For example, each of the energy supply units is designed in such a way that a single energy supply unit can supply sufficient energy to up to two brake actuator units when fully activated but is overloaded when supplying more than two fully activated brake actuator units. The capacity of the energy supply units is thus designed for normal operation in which both energy supply units are operational.

The braking system can also have more than two energy supply units, for example one energy supply unit per brake actuator unit. In the event of failure of one energy supply unit, the relevant brake actuator unit can be interconnected with a functioning energy supply unit via the switching unit.

Each of the brake actuator units comprises, for example, an electromechanical brake actuator. In particular, each of the brake actuator units comprises an electric motor and a spindle drive by which brake actuation can be affected.

The brake actuator units are in dry, i.e. they are not driven hydraulically.

For example, the control unit is configured to activate the switching unit in order to connect the brake actuator units in terms of energy either to the first energy supply unit or the second energy supply unit. The control unit thus activates both the brake actuator units and the switching unit, as a result of which activation can take place quickly. More example, the brake actuator units and the switching unit can be activated at the same time, as a result of which it is possible to react quickly to a change in a dynamic driving situation.

An independent switch is assigned to each brake actuator unit in order to switch a supply of current to the respective brake actuator unit between the first energy supply unit and the second energy supply unit. In this way, it is possible to switch simply between the two energy supply units. In other words, the switching unit has low complexity, which in turn has an advantageous effect on the production costs.

According to one exemplary arrangement, the switches assigned to the brake actuator units which can be assigned to the wheels situated diagonally with respect to the centre of the vehicle are rigidly connected to one another such that they can only be switched together. This means that the brake actuator units which can be assigned to the wheels situated diagonally with respect to the centre of the vehicle can be connected at the same time only to the same energy supply unit. The switching options of the switching unit are consequently limited to the dynamic driving situations which usually occur, whilst the complexity of the switching unit is further reduced. At the same time, activation of the switching unit is simplified because only one switch needs to be activated in order to switch two switches simultaneously.

The control unit is configured, for example, to identify a failure of an energy supply unit on the basis of the current consumption of the brake actuator units and in each case to connect the energy supply unit which has not failed to the brake actuator units. The control unit can thus identify indirectly via the brake actuator units whether an energy supply unit has failed. The control unit consequently does not have to be connected to the energy supply units, which contributes to a simple structure of the braking system. Connecting the energy supply unit which has not failed to the brake actuator units ensures that all the brake actuator units can be activated when required.

A method for braking a vehicle with a braking system according to the disclosure is also provided, wherein initially in each case two brake actuator units are interconnected with one of the two energy supply units, and wherein, in the event of a failure of one of the two energy supply units, the two brake actuator units initially interconnected with the failed energy supply unit are interconnected with the functioning energy supply unit via the switching unit. In other words, in the event of a failure of one energy supply unit, all the brake actuator units are interconnected with the still functioning energy supply unit. Furthermore, all the brake actuator units can thus be activated, as a result of which safe onward travel is ensured even in the event of a partial failure of the braking system.

For example, in the event of a partial failure, the control unit sends a signal to a central onboard computer of a vehicle in which the braking system is used. A user can consequently be informed about the partial failure.

According to one exemplary arrangement, the control unit monitors the total current consumed by the brake actuator units. For example, the control unit can optionally limit the total current consumed, which takes place by corresponding activation of the brake actuator units. Monitoring and limiting the total current ensure that the total current consumed does not exceed the capacity of the energy supply units. This is relevant when, after a partial failure of a brake actuator unit, for example at least one brake actuator unit is simultaneously interconnected with a single energy supply unit.

In one exemplary arrangement, the control unit controls a maximum possible current consumption of the brake actuator units from a single energy supply unit according to a dynamic driving situation. In this way, a braking process can be performed optimally. To be more precise, distribution of the braking force over the at least two brakable wheels is optimized.

### BRIEF DESCRIPTION OF DRAWINGS

Further advantages and features of the disclosure can be found in the following description and the attached drawings to which reference is made. In the drawings:

FIG. 1 shows a braking system according to the disclosure, and

FIG. 2 shows a diagram for illustrating current consumption of a brake actuator unit over an activation range.

### DETAILED DESCRIPTION

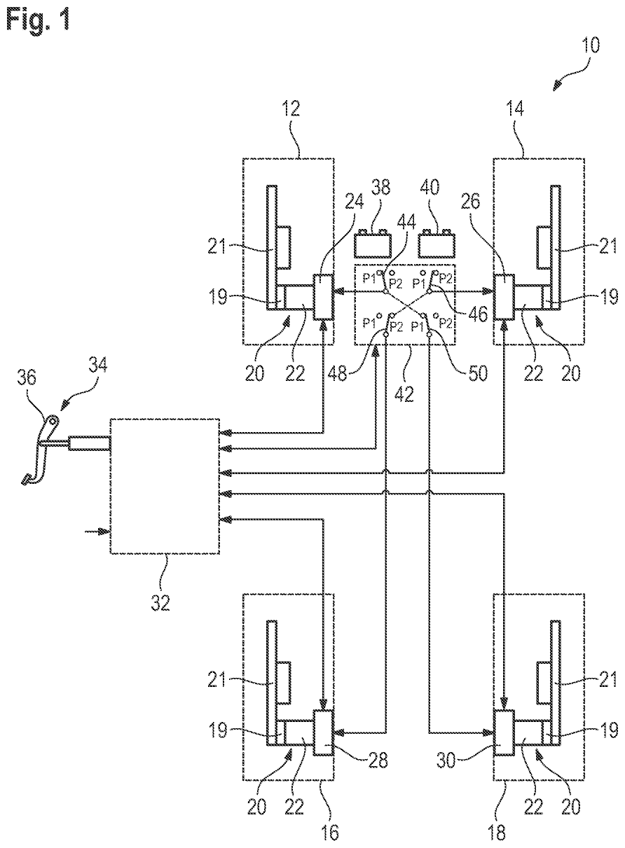

A braking system 10 for a vehicle with four brakable wheels 12, 14, 16, 18 is illustrated in FIG. 1. For example, the vehicle has two front wheels and two rear wheels.

One brake actuator unit 20 is assigned with each of the wheels 12, 14, 16, 18.

In each case one brake shoe 19 assigned to a wheel 12, 14, 16, 18 can be moved and pressed against a brake disc 21 by means of the brake actuator units 20 in order to brake the vehicle.

The brake actuator units 20 each comprise an electromechanical actuator 22 with an electric motor and a spindle drive which are not illustrated in FIG. 1 for the sake of simplicity. A hydraulic actuator is not provided.

Each brake actuator unit 20 furthermore comprises an electronic actuator control unit 24, 26, 28, 30.

The actuator control units 24, 26, 28, 30 are configured to activate the brake actuator units 20 in order to exert a braking force on an assigned wheel 12, 14, 16, 18.

For this purpose, each of the actuator control units 24, 26, 28, 30 comprises an electronic activation system for activating the assigned brake actuator unit 20.

The brake actuator units 20 are activated when a corresponding braking signal is transmitted to the actuator control units 24, 26, 28, 30.

The brake actuator units 20 activated by a central control unit 32. For this purpose, the central control unit 32 is connected by signals to the brake actuator units 20, to be more precise to the actuator control units 24, 26, 28, 30.

In order to further increase the operational safety of the braking system 10, the corresponding signal lines can be designed redundantly.

The control unit 32 is configured to monitor a total current consumed by the brake actuator units 20.

In order to be able to generate a braking signal, the braking system 10 comprises a brake actuation unit 34 with a brake pedal 36. The braking signal is generated by a driver actuating the brake pedal 36 of the brake actuation unit 34 with their foot and thus signalling their intention to brake.

It is, however, also conceivable that the braking signal is transmitted to the control unit from outside the brake actuation unit 34, for example in an autonomous or semi-autonomous driving mode.

The braking system 10 furthermore has a first energy supply unit 38 and a second energy supply unit 40. The energy supply units 38, 40 can be connected independently of each other.

The energy supply units 38, 40 are configured to supply the brake actuator units 20 with energy, for example, the actuators 22 and the actuator control units 24, 26, 28, 30.

The control unit 32 is configured to control a maximum possible current consumption of the brake actuator units 20 from a single energy supply unit 38, 40 according to a dynamic driving situation.

The braking system 10 furthermore comprises a switching unit 42 which is configured to connect the brake actuator units 20 in terms of energy either to the first energy supply unit 38 or the second energy supply unit 40 in order to enable the supply of energy to the corresponding brake actuator unit 20 from the energy supply unit which is connected in each case.

For this purpose, an independent switch 44, 46, 48 is assigned to each brake actuator unit 20 in order to switch a supply of current to the respective brake actuator unit 20 between the first energy supply unit 38 and the second energy supply unit 40.

The control unit 32 can be configured to activate the switching unit 42 accordingly, and thus shift the switches 44, 46, 48, 50 accordingly, in order to connect the brake actuator units 20 in terms of energy either to the first energy supply unit 38 or the second energy supply unit 40.

The switches assigned to the brake actuator units 20 which can be assigned to the wheels situated diagonally with respect to the centre of the vehicle are optionally rigidly connected to one another such that they can only be switched together. This is illustrated in FIG. 1 in each case by a dashed connecting line.

In fault-free operation, the first energy supply unit 38 supplies energy to the brake actuator unit 20 assigned to a front wheel and to the brake actuator unit 20 assigned to a rear wheel situated diagonally with respect to the centre of the vehicle. The second energy supply unit 40 correspondingly supplies energy to the brake actuator unit 20 assigned to other front wheel and to the brake actuator unit 20 assigned to a rear wheel situated diagonally with respect to the centre of the vehicle.

Fault-free operation exists when all the components of the braking system 10 are functioning properly.

Each of the energy supply units 38, 40 is, for example, designed in such a way that a single energy supply unit 38, 40 can supply sufficient energy to up to two brake actuator units 20 when fully activated. A single energy supply unit 38, 40 would, however, be overloaded when supplying more than two fully activated brake actuator units 20.

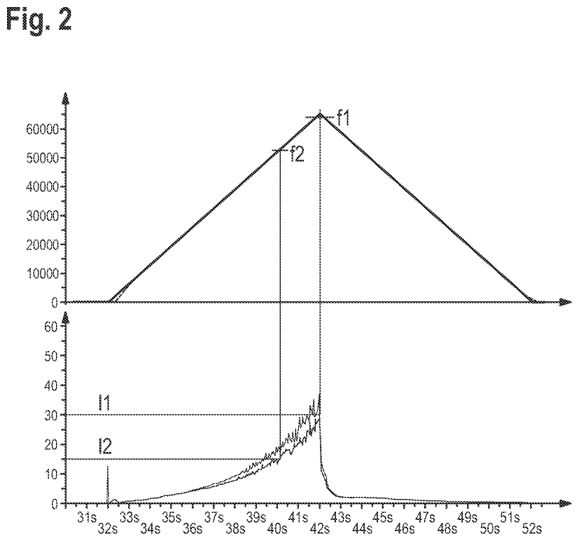

A method for operating the braking system 10 is described below with reference to FIG. 1 and FIG. 2, which shows a diagram for illustrating current consumption of a brake actuator unit 20 over an activation range.

Initially in each case two brake actuator units 20 are interconnected with one of the two energy supply units 38, 40, in particular interconnected diagonally, as illustrated in FIG. 1. This switching state exists in fault-free operation of the braking system 10.

The position of a switch in which the first energy supply unit 38 is interconnected is illustrated by P1 in FIG. 1 and the position in which the second energy supply unit 40 is interconnected by P2.

Specifically, in the exemplary arrangement, initially the left front wheel 12 and the right rear wheel 18 are interconnected to the first energy supply unit 38, and the right front wheel 14 and the left rear wheel 16 are interconnected to the second energy supply unit 40.

The control unit 32 is configured to identify a failure of an energy supply unit 38, 40 on the basis of a current consumption of the brake actuator units 20.

For this purpose, the control unit 32 preferably continuously monitors a total current consumed by the brake actuator units 20.

In the event of a failure of one of the two energy supply units 38, 40, the two brake actuator units 20 interconnected initially to the failed energy supply unit 38, 40 are interconnected to the functioning energy supply unit 38, 40 via the switching unit 42.

The control unit 32 subsequently prevents a total current consumed by the brake actuator units 20 from exceeding the capacity of the functioning energy supply unit 38, 40. This also takes place based on the monitoring of the total current.

For example, the control unit 32 controls a maximum possible current consumption of the brake actuator units 20 from a single energy supply unit 38, 40 according to a dynamic driving situation.

When it is desired to decelerate the vehicle as rapidly as possible, for example, in the case of an emergency stop or a braking process at a high vehicle speed, at least the majority of the available braking power is distributed to the front wheels 12, 14.

In the case of a braking process in which ESP control takes place, the available braking power is distributed uniformly to all the wheels 12, 14, 16, 18.

By virtue of the fact that the brake actuator units 20 have a non-linear efficiency curve, even in the event of failure of one of the two energy supply units 38, 40 a braking force of more than 50%. In one exemplary arrangement, the braking force is more than 80% of the original braking force, can still be achieved depending on the driving situation.

This can be seen in FIG. 2 which illustrates a possible clamping force of an individual brake actuator unit 20 above a working characteristic of the brake actuator unit 20.

The current fed into a brake actuator unit 20 determines the achievable torque of the electric motor of the brake actuator unit 20.

The torque is translated by rotary and longitudinal translation stages into a clamping force.

In fault-free operation, a current consumption of the brake actuator unit 20 at maximum activation is, for example, I1=30 A with a supply voltage of 12.3 V. In this case, a clamping force of f1=63 kN is achieved in the exemplary arrangement.

If current consumption of an individual brake actuator unit 20 is limited in the event of failure of an energy supply unit 38, 40 to, for example, 50%, to I2=15 A, at maximum activation a clamping force of 55 kN is achieved, which in the exemplary arrangement is a clamping force of 87% compared with fault-free operation.

The reason for this is that the efficiency of a brake actuator unit 20 is increased when the current consumption is limited.

It is also conceivable that current consumption of the brake actuator unit 20 is further limited by the control unit 32, in order to achieve a further improvement in efficiency. This is advantageous in the case of a loss of power from the remaining energy supply unit 38, 40.

For example, the current consumption can be limited to 5 A. In this case, a clamping force of approximately 50% of the maximum clamping force can be achieved, which corresponds to approximately 30 kN in the exemplary arrangement.

In the case of such a limitation of the current consumption, a so-called “minimal risk manoeuvre” can be possible, i.e. the vehicle can continue to be manoeuvred until it can be parked in a safe area. For example, the vehicle can be moved to a service station or a parking area.

Current consumption at a supply voltage of 10.8 V is additionally illustrated in FIG. 2.

The values mentioned are, however, only given by way of example.

In an alternative arrangement, which is not illustrated for the sake of simplicity, the braking system 10 has more than two energy supply units, for example one energy supply unit per brake actuator unit 20. In the event of failure of one energy supply unit, the relevant brake actuator unit 20 can be interconnected to a functioning energy supply unit via the switching unit 42.

1. A Braking system for a vehicle with at least two brakable wheels, comprising,
at least two brake actuator units which can be assigned in each case to one of the wheels of the vehicle,
at least a first energy supply unit and a second energy supply unit for supplying the brake actuator units with electrical energy,
a control unit which is configured to activate the brake actuator units in order to exert a braking force on an assigned wheel, and
a switching unit which is configured to connect the brake actuator units in terms of energy either to the first energy supply unit or the second energy supply unit in order to enable the supply of energy to the corresponding brake actuator unit from the respective energy supply unit which is connected in each case.

2. The braking system according to claim 1, wherein each of the energy supply units designed in such a way that a single energy supply unit of the first and second energy supply units can supply sufficient energy to up to two brake actuator units when fully activated but is overloaded when supplying more than two fully activated brake actuator units.

3. The braking system according to claim 1, wherein the control unit configured to activate the switching unit in order to connect the brake actuator units in terms of energy either to the first energy supply unit the second energy supply unit.

4. The braking system according to claim 1, wherein an independent switch is assigned to each brake actuator unit in order to switch a supply of current to the respective brake actuator unit between the first energy supply unit and the second energy supply unit.

5. The braking system according to claim 4, wherein the switches assigned to the brake actuator units which can be assigned to the wheels situated diagonally with respect to a centre of the vehicle are rigidly connected to one another such that the actuator units can only be switched together.

6. The braking system according to claim 1, wherein the control unit is configured to identify a failure of an energy supply unit on a basis of current consumption of the brake actuator units and in each case to connect the energy supply unit which has not failed to the brake actuator units.

7. A method for braking a vehicle with a braking system according to claim 1, wherein initially in each case two brake actuator units are interconnected with one of the first and second energy supply units, and wherein, in an event of a failure of one of the first and second energy supply units, the two brake actuator units initially interconnected with the failed energy supply unit are interconnected with the functioning energy supply unit via the switching unit.

8. The method according to claim 7, wherein the control unit monitors a total current consumed by the brake actuator units.

9. The method according to claim 7, wherein the control unit controls a maximum possible current consumption of the brake actuator units from a single energy supply unit of the first and second energy supply units according to a dynamic driving situation.

10. The method according to claim 8, wherein the control unit controls a maximum possible current consumption of the brake actuator units from a single energy supply unit of the first and second energy supply units according to a dynamic driving situation.

11. The braking system according to claim 2, wherein the control unit is configured to activate the switching unit in order to connect the brake actuator units in terms of energy either to the first energy supply unit or the second energy supply unit.

12. The braking system according to claim 11, wherein an independent switch is assigned to each brake actuator unit in order to switch a supply of current to the respective brake actuator unit between the first energy supply unit and the second energy supply unit.

13. The braking system according to claim 11, wherein the control unit is configured to identify a failure of an energy supply unit on a basis of current consumption of the brake actuator units and in each case to connect the energy supply unit which has not failed to the brake actuator units.
